(19) United States
(12) Patent Application Publication
(10) Pub. No.: US 2014/0168957 A1
(43) Pub. Date: Jun. 19, 2014

(54) LIGHT RECYCLING SYSTEM

(71) Applicant: JOEL TAFT, Milford, MA (US)

(72) Inventor: JOEL TAFT, Milford, MA (US)

(21) Appl. No.: 13/718,320

(22) Filed: Dec. 18, 2012

(51) Int. Cl. F21L 4/02; F21L 4/08

(52) U.S. Cl. CPC F21L 4/02; F21L 4/08
USPC 362/183

(57) ABSTRACT

A light recycling device comprising a light fixture, where the light fixture includes an inner wall, a power housing and a light bulb; a solar panel attached to the inner wall of the light fixture, where the solar panel collects energy emitted from a plurality of light rays from the light bulb; a power out connection coupled to the solar panel, where the power out connection transfers the energy received by the solar panel; and a power in connection coupled to the power housing, where the power connection receives electricity to illuminate the light bulb. Multiple light recycling devices may be connected to supplement or offset the amount of electricity outputted from a power grid.

### CROSS REFERENCE TO OTHER APPLICATIONS

This application claims priority to U.S. Provisional Application Ser. No. 61/608,878 filed on Feb. 27, 2012.

### BACKGROUND OF THE INVENTION

1. Field of the Invention

The present invention relates to a system to cycle power utilizing solar panels within a light fixture which receive power from indoor light sources.

2. Description of Related Art

Solar power is the conversion of sunlight into energy, commonly by the photovoltaic use of solar panels. Solar power consumption is available in large and small scale ranging from simply powering a calculator or an entire building. Utilizing the energy from the sun supplements or completely replaces the necessity for external electricity sources allowing some structures to be completed powered by solar energy.

While conversion of sunlight into energy is a current trend amongst homeowners and businesses, once inside the sun does not shine thus artificial light is necessary. Homes and businesses are readily equipped with light fixtures throughout the building which provide light. Depending on the number of fixtures and the amount of time left on, the energy consumption in the building may be very high. With all the light energy radiated from the light fixtures it would be desirable to harness some of this energy to offset the external energy consumption required to power the building.

### SUMMARY OF THE INVENTION

In view of the foregoing disadvantages inherent in the prior art, the general purpose of the present invention is to provide a light recycling system, configured to include all of the advantages of the prior art, and to overcome the drawbacks inherent therein.

Accordingly, an object of the present invention is to provide a light recycling device where a solar panel is positioned within a light fixture to collect the light energy emitted by the internal light bulb, and to convert that energy into electricity.

Another object of the present invention is to utilize multiple light recycling devices to create a light recycling system to supplement or completely offset the amount of external electricity necessary to power a house or building.

To achieve the above objects, in an aspect of the present invention, a light recycling device is described comprising a light fixture, where the light fixture includes an inner wall, a power housing and a light bulb; a solar panel attached to the inner wall of the light fixture, where the solar panel collects energy emitted from a plurality of light rays from the light bulb; a power out connection coupled to the solar panel, where the power out connection transfers the energy received by the solar panel; and a power in connection coupled to the power housing, where the power connection receives electricity to illuminate the light bulb. Multiple light recycling devices may be connected to supplement or offset the amount of electricity outputted from a power grid.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a light recycling device in accordance with an exemplary embodiment of the present invention; and

FIG. 2 depicts a schematic view of a light recycling system in accordance with an exemplary embodiment of the present invention.

Like reference numerals refer to like parts throughout the description of several views of the drawings.

### DETAILED DESCRIPTION OF THE DRAWINGS

The present invention relates to a system to cycle power utilizing solar panels positioned within a light fixture which receive power from indoor light sources. The light recycling system comprises a flexible solar panel positioned within a light fixture to capture energy from the artificial light. Once accumulated, the unused energy is sent to the voltage amplifier/regulator and redistributed back to the grid to offset electricity consumption.

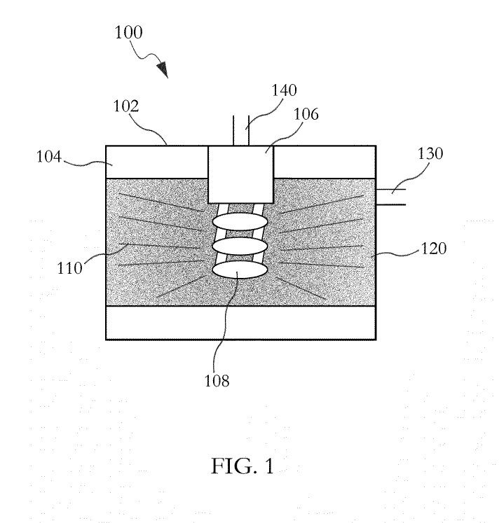

Turning now descriptively to the drawing, referring to FIG. 1, a perspective view of a light recycling device 100 is shown in accordance with an exemplary embodiment of the present invention. The light recycling device 100 includes a light fixture 102, where the light fixture 102 includes an inner wall 104, a power housing 106, and a light bulb 108. The light fixture 102 may be a circular, square or an abstract shape depending on design choices, and may be used for indoor or outdoor lighting. The light bulb 108 is powered by electricity received from the power housing 106, which allows the light bulb 108 to illuminate and cast a plurality of light rays 110 radially from the bulb 108. The light bulb 108 may be a variety of different lights including incandescent, fluorescent, high intensity discharge or the like.

Within the light fixture 102 is a solar panel 120 positioned to the inner wall 104. The solar panel 120 is flexible and attached to a mat as a backing to allow the solar panel 110 to conform and adapt to the inner wall 104 of the light fixture 102. Depending on the shape and size of the light fixture 102, the solar panel 120 is adapted to fit against the inner wall 104 accordingly. The solar panel 120 may be positioned on any portion of the inner wall 104 that receives light rays 110 from the light bulb 108, for example on the sides, above or below the bulb 108, while leaving a portion of the light fixture exposed to the outside to allow the fixture 102 to still be a functioning fixture.

The solar panel 120 may electrically coupled to a proximal light fixture 102 or a voltage amplifier/regulator. The solar panel 120 transfers the energy absorbed from the light rays 110 through a power out connection 130. The power out connection 130 may then transfer the accumulated energy to another light fixture 102 or to the regulator. If energy transfer is to another light fixture 102 the energy is received at a power in connection 140 coupled to the power housing 106. The power in connection 140 may also receive power from an external electrical source.

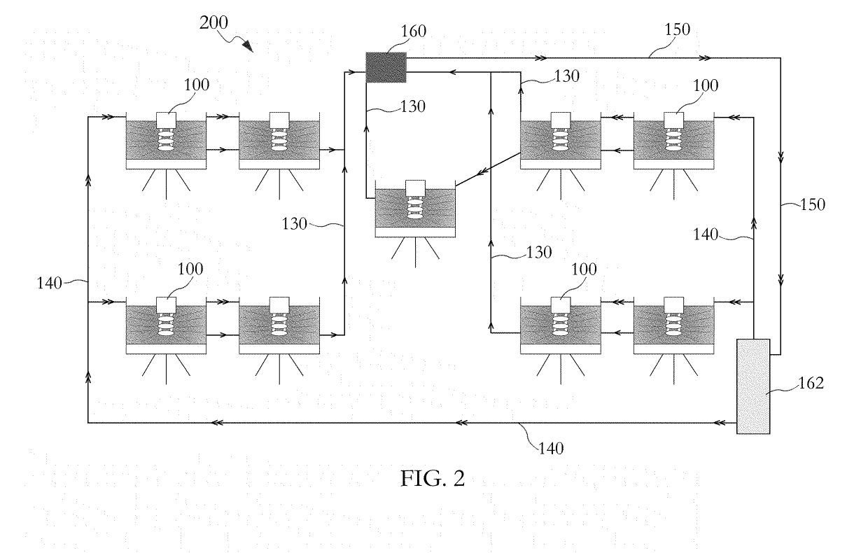

Referring now to FIG. 2, a schematic illustration of the light recycling system 200 is shown in accordance with an exemplary embodiment of the present invention. The schematic is for illustrative purposes and is not meant as a limiting illustration of the present system. The individual light recycling devices 100 are positioned in various area of a house or building where in each room or hallway one or more light recycling devices 100 may be utilized. The power out connection 130 joins multiple light recycling devices 100 together and transfers the collected light ray energy from the solar panels to a voltage amplifier/regulator 160. From the regulator 160 the collected electricity 150 flows into an electrical panel or grid 162. The collected electricity 150 may supplement or replace the external electrical power received by the grid 162. From the grid 162 the electricity flows through the power in connection into the light recycling devices 100 thereby powering the light bulb for illumination. Thus the light recycling system 200 creates a cycle where the device 100 receives power from the grid 162, collects the energy emitted by the light rays into solar panels within the device 100, transfers the energy from the device 100 into the regulator 160, where it is consolidated and finally transferred back into the grid 162 to either supplement or replace the external electrical power received. The system 200 may reduce or eliminate the external electricity necessary to power the grid 162.

The light recycling system 200 may save users money and energy consumption by offsetting the amount of power used in the house or building by collecting the unused light energy and sending it back to the grid. The system 200 may operate is indoor or outdoor environments, to collect the emitted light energy and convert it into electricity used to power other devices.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A light recycling device comprising:
a. a light fixture, where the light fixture includes an inner wall, a power housing and a light bulb;
b. a solar panel attached to the inner wall of the light fixture, where the solar panel collects energy emitted from a plurality of light rays from the light bulb;
c. a power out connection coupled to the solar panel, where the power out connection transfers the energy received by the solar panel; and
d. a power in connection coupled to the power housing, where the power connection receives electricity to illuminate the light bulb.

2. The light recycling device according to claim 1, where the light fixture is an outdoor fixture.

3. The light recycling device according to claim 1, where the light fixture is an indoor fixture.

4. The light recycling device according to claim 1, where the solar panel is flexible to enable the solar panel to easily adapt to the inner wall of the light fixture.

5. The light recycling device according to claim 1, where the power out connection connects the light fixture to one of at least another light recycling device and a voltage amplifier/regulator.

6. The light recycling device according to claim 1, where the power in connection receives power from one of at least another light recycling device and a power grid.

7. The light recycling device according to claim 1, where the light bulb is one of at least an incandescent light, a fluorescent light, and a high intensity discharge light.

8. A light recycling system comprising:
a. at least one light recycling device, where the light recycling device includes:
i. a light fixture;
ii. a solar panel fastened to an inner wall of the light fixture;
iii. a power out connection coupled to the solar panel;
iv. a power in connection coupled to a power housing within the light fixture;
b. a voltage amplifier/regulator coupled to the light recycling device to accumulate energy received from the solar panel; and
c. a power grid coupled to the voltage amplifier/regulator, where the power grid received the accumulated electricity, and where the accumulated electricity cycles back into the light recycling system from the grid to be received by the light recycling device.

9. The light recycling system according to claim 8, where the system includes a plurality of light recycling devices coupled to each other.
